(19) United States
(12) Patent Application Publication
(10) Pub. No.: US 2002/0178256 A1
(43) Pub. Date: Nov. 28, 2002

(54) System and method for introducing redundancy mechanisms into a communication system

(76) Inventors: Johann Arnold, Wendelstein (DE); Michael Franke, Erlangen (DE); Martin Kiesel, Poxdorf (DE); Karl-Heinz Krause, Nurnberg (DE)

Correspondence Address: BAKER & BOTTS, 30 ROCKEFELLER PLAZA, NEW YORK, NY, 10112

(21) Appl. No.: 10/013,139

(22) Filed: Dec. 10, 2001

(30) Foreign Application Priority Data
Mar. 16, 2001 (DE) 101 133 97.9
Sep. 14, 2001 (DE) 101 455 18.6

(51) Int. Cl. G06F 15/173

(52) U.S. Cl. 709/224

(57) ABSTRACT

System and method for introducing redundancy mechanisms into a communication system, comprising the following steps:

a. Transmission of a data message for synchronization from a timing generator via disjoint paths to the nodes,

b. In the case of an interruption of the transmission in one of the disjoint paths:

i. Transmission of the data message from the timing generator via a first partial path of the interrupted path and

ii. Transmission of the data message from the timing generator via the uninterrupted path and from there via a second partial path of the interrupted path.

### FIELD OF INVENTION

The invention relates to a system and method for introducing redundancy mechanisms into a communication system.

### BACKGROUND OF THE INVENTION

The reference DE 42 15 380 A1 discloses a method for synchronizing local timers of an automation system wherein a local timer is synchronized with time information which is formed from the time information of a central timer and a correction corresponding to the transmission and processing time. The time information is only transmitted by a transmission unit belonging to the central timer when it deviates by less than a predetermined amount from the current time. The disadvantage with this known method is that when the central timer fails or the bus line to the central timer is interrupted, the local timers can no longer be synchronized.

The reference DE 197 03 963 A1 discloses a method for exchanging data between electronic modules which can be arranged remotely. In this method, one module is used as clock generator without any redundancy mechanism.

Various standardized communication systems, also called bus systems, for exchanging data between two or more electronic modules or devices are known, especially also for use in automation systems also known in the prior art. Examples of such communication systems are fieldbus, Profibus, Ethernet, industrial Ethernet, FireWire or also bus systems within PCs (PCI). These bus systems are designed or optimized for different fields of application and allow a decentralized control system to be built up. The process control and monitoring in automated production and especially in digital drive technologies require very fast and reliable communication systems with predictable response times.

A very fast and simple communication between various modules can be built up by means of parallel bus systems such as, for example, SMP, ISA, PCI or VME. These known bus systems are used, in particular, in computers and PCs.

Synchronous clocked communication systems having equidistant characteristics are known from automation technology. They are understood to be a system of at least two users which are connected to one another via a data network for the purpose of the mutual exchange of data or the mutual transmission of data. The data exchange takes place cyclically in equidistant communication cycles which are predetermined by the communication clock used by the system. Users are, for example, centralized automation devices, programming, planning or operating devices, peripheral devices such as, e.g., input/output modules, drives, actuators, sensors, stored-program controls (SPCs) or other control units, computers or machines which exchange electronic data with other machines, particularly process data from other machines. In the text which follows, control units are understood to be closed-loop or open-loop control units of any type.

An equidistant deterministic cyclic data exchange in communication systems is based on a common clock or time base of all components involved in the communication. The clock or time base is transmitted to the other components by a distinct component (timing generator). In an isochronous real-time Ethernet, the clock or time base is predetermined by a synchronization master by sending synchronization messages. When the timing generator component or a connecting path of the timing generator fails, the clock or time base for the remaining components involved in the communication fails.

### SUMMARY OF THE INVENTION

It is the object of the invention to prevent a loss of a clock or time base for the other components involved in a communication system.

This object is achieved by a method for synchronizing nodes of a communication system wherein a data message is transmitted for synchronization from a timing generator via disjoint paths to the nodes and in the event of an interruption of the transmission in one of the paths, the data message is transmitted via a first partial path of the interrupted path, and transmitting the data message via an uninterrupted path and from there via a second partial path of the interrupted path.

Accordingly, a redundancy mechanism for the clock synchronization is established in such a manner that the clock is transmitted on disjoint paths by a timing generator. This principle can be applied both when only one timing generator is used or also when a number of timing generators are used. If there is a break in one of the paths, the corresponding data messages of the timing generator are fed into the subnetworks produced due to the break.

In a preferred embodiment of the invention, a redundancy mechanism is introduced in which there are a number of timing generators, each having a different priority in the communication system. In this arrangement, the timing generator having the highest priority also synchronizes all other timing generators so that the clock signals of timing generators and of replacement timing generators are almost identical in normal operation. If the timing generator with the highest priority fails, the timing generator having the next highest priority is then automatically selected as the timing generator for a particular node in the communication system. This selection can be done in such a manner that each data message of a timing generator also contains its priority and a node in the communication system can then select the data message of the timing generator with the highest priority by means of the priority. The priorities can be permanently allocated or the priorities can be newly issued, for example when one of the timing generators fails. For example, when the timing generator with the highest priority fails, a replacement timing generator can be selected via corresponding planning of the communication system. It is particularly preferred if the timing generators can have information on the timing generators existing or planned in the system so that prioritization takes place, for example, via the planning. In the nodes of the communication system which are to be synchronized, it is either only the clock signal with the highest priority available at the relevant node which is used, or a clock signal weighted from a number of or all clock signals available at a node which is generated. The weighting can be generated by averaging the individual clock signals or by another type of filtering.

The present invention allows a redundancy mechanism to be introduced into a communication system by means of the simultaneous use of a number of timing generators or by means of a mechanism for activating replacement timing generators in the case of a malfunction. An advantage of this arrangement is the increase in availability of such systems which can be achieved by means of the invention, since the failure of a single component (timing generator) or of a connecting path does not lead to the failure of the total system. This advantage according to the invention is of particular significance in an application for packaging machines, presses, plastic injection moulding machines, textile machines, printing machines, machine tools, robots, handling systems, wood processing machines, glass processing machines, ceramic processing machines and lifting tools.

### BRIEF DESCRIPTION OF THE DRAWINGS

Preferred exemplary embodiments of the invention are described hereinbelow in greater detail, in connection with the drawings, in which:

FIG. 1 shows a block diagram of a first embodiment of a communication system according to the invention;

FIG. 2 shows a flowchart of a first embodiment of the method according to the invention;

FIG. 3 shows a block diagram of a second preferred embodiment of a communication system according to the invention, having at least one replacement timing generator;

FIG. 4 shows a flowchart of a second embodiment of the method according to the invention, having at least one replacement timing generator; and

FIG. 5 shows a flowchart of a further embodiment of the method according to the invention, having replacement timing generators.

### DETAILED DESCRIPTION OF THE INVENTION

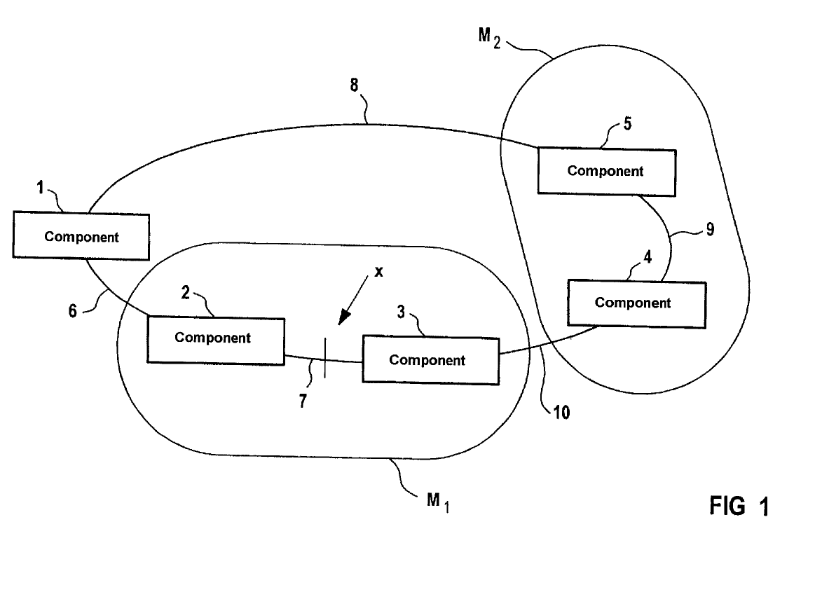

FIG. 1 shows an embodiment of a communication system according to the invention comprising nodes 1 to 5. Each of the nodes 1 to 5 contains a component device of the communication network such as a timing generator or a control unit. The component of node 1 is a timing generator which generates data messages for synchronizing the components of the other nodes 2 to 5. These data messages are transmitted in the communication system via lines 6 to 10 which connect the individual nodes 1 to 5 to one another. In this arrangement, a data message is transmitted from node 1, on the one hand, via a path P₁ which contains lines 6 and 7, to nodes 2 and 3. Nodes 2 and 3 form a set M₁ which belongs to path P₁. On the other hand, the data messages are transmitted to nodes 4 and 5 via lines 8 and 9. Furthermore, nodes 3 and 4 are connected to one another via a line 10. Lines 8, 9 and 10 form a path P₂ to which the set M₂ of nodes 4 and 5 belongs. The two paths P₁ and P₂ are connected to one another at their end points by line 10 of path P₂. Due to the ring topology resulting from this, both the data message sent via path P₁ and the data message sent via path P₂, of the timing generator of node 1 can be received in each of nodes 2 to 5.

For synchronization the relevant component in a node can then only use the data message which has been sent out via the path to which the relevant component belongs. In the case of node 2 this means that the component of node 2 only evaluates the data message of the timing generator of node 1 which has been received via line 6.

It is also possible for a component to use both data messages, i.e., both the data message of the path to which the component belongs and the data message of the other path) for synchronization so that, for example, a signal weighted or filtered for synchronization is generated from the two data messages. For the component of node 2, this means that both the data message of the timing generator of component 1 received via line 6 and that received via line 7 are used for synchronization.

In the case of a fault, for example if there is a break at the location on the network identified by the vertical line X in line 7 in FIG. 1. This means that path P₁ is opened between nodes 2 and 3. The result is a partial path P₁₁ with line 6 and node 2 and a partial path P₁₂ with node 3. In this case, nodes 2 to 5 of the communication system are supplied with data messages for synchronization via the resultant subnetworks, i.e., the component of node 2 receives a data message from the timing generator of node 1 via line 6, and components 4 and 5 receive a data message via lines 8 and 9 of path P₂. The partial path P₁₂ consisting of node 3 is connected to path P₂ via line 10 so that the component of node 3 also receives a data message for synchronization in spite of the break in line 7. The disjoint paths of P₁ and P₂ thus ensure that the communication system can continue to work even in the case of a line break.

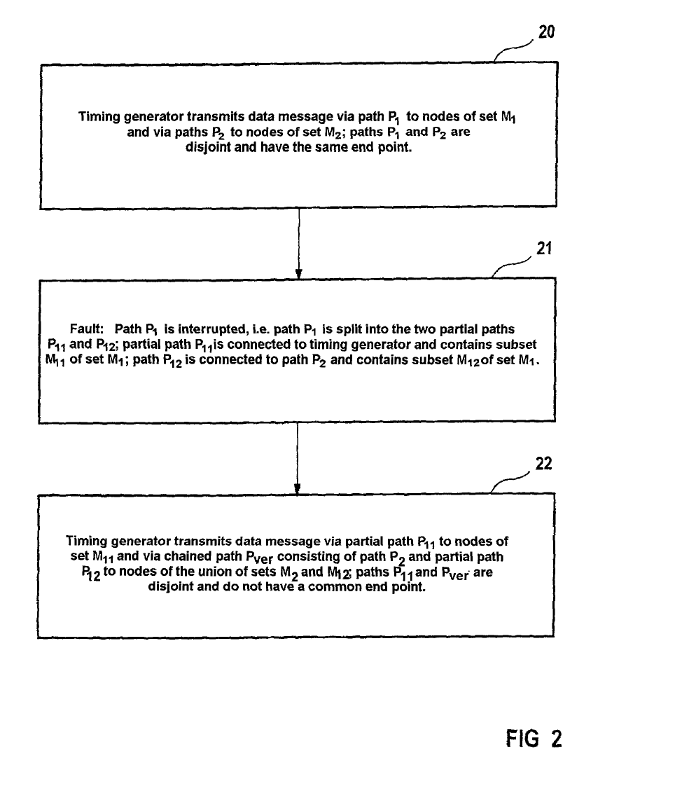

FIG. 2 shows a corresponding flowchart for the embodiment shown in FIG. 1. In normal operation of the communication system (step 20), data messages from a timing generator of the communication system are transmitted via disjoint paths. Thus, the data messages are transmitted via path P₁ to nodes of the communication system of set M₁, and via a path P₂ to nodes of set M₂. Paths P₁ and P₂ are disjoint and preferably have the same end point or are connected to one another via a line at their end points.

In step 21, a fault occurs resulting in an interruption in path P₁ and path P₁ is split into two partial paths P₁₁ and P₁₂. The partial path P₁₁ has a direct connection to the node of the communication system which contains the timing generator. This partial path P₁₁ has a subset M₁₁ of nodes of set M₁. Partial path P₁₂ does not have a direct connection to the node of the communication network with the timing generator and contains a subset M₁₂ of nodes of set M₁. Partial path P₁₂, however, has a connection to path P₂.

In step 22, the timing generator transmits a data message via partial path P₁₁ to the nodes of set M₁₁. Due to the break in path P₁, a chained path Pᵥₑᵣ is produced which consists of the interconnected paths P₂ and P₁₂. The timing generator transmits the corresponding data message to the nodes of the union of sets M₂ and M₁₂ via this chained path. The resultant paths P₁₁ and Pᵥₑᵣ are also disjoint but do not have a common end point or a connection between their end points.

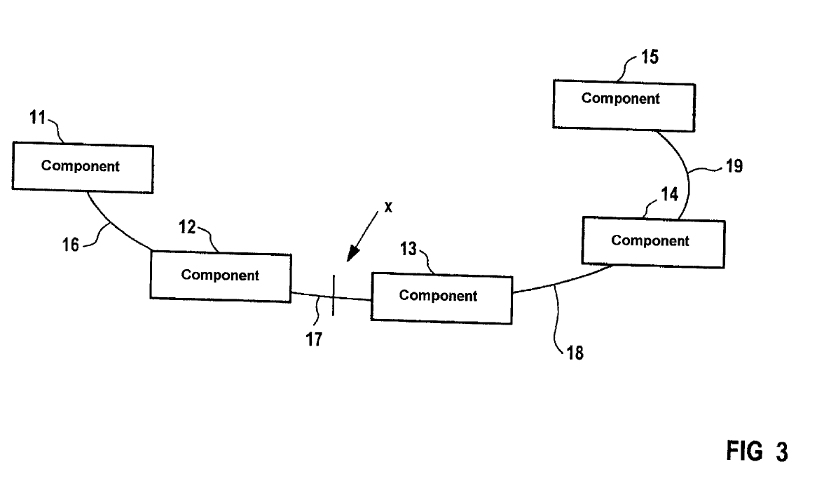

FIG. 3 shows an alternative embodiment of a communication system according to the present invention. The communication system of FIG. 3 contains nodes 11 to 15 which are connected to one another via lines 16 to 19. A timing generator each is located in at least two different nodes of the communication system; these are nodes 11 and 15 in the example of FIG. 3. The timing generators of nodes 11 and 15 have different priorities. For example, the timing generator of node 11 is the timing generator with the highest priority and the timing generator of node 15 is a timing generator with a lower priority which is also called the replacement timing generator.

In normal operation, both the timing generator of the node 11 and the replacement timing generator of node 15 are active and send out corresponding data messages. The priority is a characteristic of the respective timing generator and is statically fixed during the parameterization of the communication system, and/or can be dynamically adapted to the respective situation. The respective priority is known to the components to be synchronized and/or is transmitted together with the data message of the clock signal. All components exclusively use the clock signal of the highest priority, which includes the replacement clock generator or generators, for their synchronization with the timing generator having the highest priority in each case. In normal operation of the communication system of FIG. 3, the timing generators of nodes 11 and 15 in each case send data message for synchronization. The respective data messages contain an identification code from which the priority of the timing generator which has sent the data message is obtained.

Thus, the components in nodes 12, 13 and 14 in each case receive two data messages having a different priority which is obtained from the respective identification code contained in the data message. The corresponding component can then select the data message from the timing generator with the higher priority and only use this for synchronization. However, the component can also take into consideration both data messages and generate a signal for synchronizing the local clock signal of the component by filtering, for example weighting the corresponding synchronization data.

In the case of a fault, for example, the timing generator in node 11 fails. In this case, the components to be synchronized in nodes 12, 13 and 14 now only receive data messages for the synchronization from the replacement timing generator of node 15 which, at the same time, is also the remaining timing generator in the communication system due to the failure of the timing generator of node 11. Thus the timing generator 15 becomes the timing generator with the highest priority and takes the place of the failed timing generator.

When the individual data messages of the timing generator and of the replacement timing generator are weighted, and when one of the timing generators fails, algorithms using previous values can be used for adapting the clock (or time base) of the relevant component to the clock signal of the remaining replacement timing generator without discontinuity. Such an algorithm can also be used when the communication system is broken, for example at the location designated by X in FIG. 3, in which case only either the clock signal of the main timing generator or the clock signal of the replacement timing generator is then received in the individual components.

If the system is interrupted at location X, e.g. due to a cable break, the network is split into two subnetworks. The components within the subnetworks, however are still synchronous due to the data message received in each case from one of the timing generators of nodes 11 and 15, respectively.

In a further preferred embodiment of the communication system as shown in FIG. 3, only the timing generator with the highest priority, that is to say the timing generator of node 11, transmits in normal operation. The data signals sent by the timing generator of node 11 are also received by the replacement timing generator of node 15. If the timing generator of node 11 fails, the replacement timing generator in node 15 no longer receives a clock signal. After a plannable number of communication cycles, the replacement timing generator of node 15 then begins to operate and sends data messages for synchronization to the components to be synchronized in the network.

The cycles between the failure of the timing generator with the highest priority in node 11 and the start of operation by the replacement timing generator of node 15 are bridged by the internal clock generation in the components. The transition from synchronization by means of the data messages received from the main timing generator to synchronization due to data messages of the replacement timing generator, or from the internal clock to the clock of the replacement timing generator, is controlled without discontinuity by algorithms using previous values. The same applies to an interruption of the system, for example at the location identified by X in FIG. 3. Assuming that both timing generators are still active in the case of such a line break, the network is again split into two subnetworks which are in each case synchronized by means of the main timing generator or the replacement timing generator, respectively.

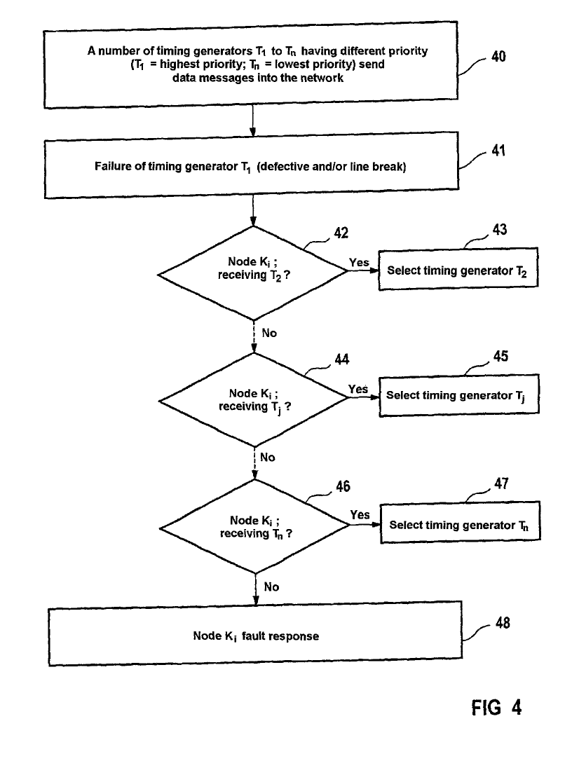

FIG. 4 shows a flowchart of another embodiment of the method according to the invention. Step 40 relates to normal operation. A number of timing generators T₁ to Tₙ in each case send data messages into the network. The individual timing generators have different priorities, i.e., each priority occurs only once in the communication system. For example, timing generator T₁ is the timing generator having the highest priority and timing generator Tₙ is the timing generator having the lowest priority, with the priorities of timing generators T₂ to Tₙ₋₁ decreasing, for example, linearly with their consecutive index.

The individual data messages of the timing generators contain an identification code from which the priority of the corresponding timing generator can be detected for each node in the communication system. For example, each node only takes into consideration for synchronization the data message originating from the timing generator T₁, i.e., the one with the highest priority. This also applies to the timing generators T₂ to Tₙ with lower priorities which in turn synchronize to the timing generator T₁ with the highest priority by means of its data messages.

In step 41, the timing generator T₁ with the highest priority fails due to a defect and/or a line break which separates the timing generator T₁ from at least some of the nodes of the communication system.

An arbitrary node Ki, which no longer receives the data messages of the timing generator T₁, is described hereinbelow. In step 42, node Kᵢ first checks whether data messages of the timing generator having the next-lower priority (the timing generator T₂,) are being received. If so, timing generator T₂ is selected by node Kᵢ as the timing generator for the further synchronization in step 43. If this is not so, node Kᵢ checks in step 44 for timing generators Tⱼ in the order of decreasing priorities as to whether a data message can be received from the relevant timing generator Tⱼ. If this is so, the relevant timing generator Tⱼ is selected for further synchronization in step 45. If not, a check is made in step 46 with regard to timing generator Tₙ having the next lowest priority as to whether a data message from this timing generator Tₙ can be received in node Kᵢ. If this is so, this timing generator is selected for further synchronization by the node Kᵢ in step 47, and if not, the failure of the relevant node Kᵢ is reported in step 48 for example by means of a signal lamp that lights up.

Depending on the type of fault, the relevant nodes can obtain different results, that is to say a different selection of timing generators, on the basis of the checks 42 and 46 running in the nodes of the communication system. For example, due to one or more line breaks, the communication network can be split into subnetworks which are then supplied by different replacement timing generators of different priority. It is particularly advantageous in this context that replacement timing generators are selected remotely in the individual nodes.

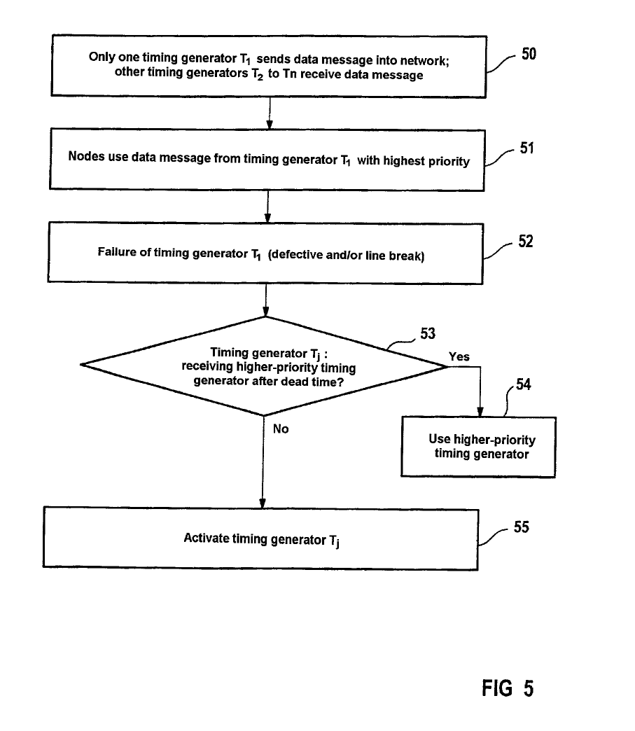

FIG. 5 shows a flowchart of a further preferred embodiment of the method according to the invention. Step 50 relates to normal operation in which only one of the timing generators, that is to say the timing generator with the highest priority e.g., T₁ sends data messages into the network of the communication system for synchronizing components. The communication system contains further timing generators T₂ to Tₙ which in each case have a decreasing priority from T₂ to Tₙ. These replacement timing generators receive the data messages of the timing generator T₁ with the highest priority, as do the other components of the communication system in the nodes of the network. However, the replacement timing generators do not send any data messages for synchronization in normal operation. Also in normal operation, the components of the nodes of the network utilize the data message of the timing generator T₁ with the highest priority for sychronizing the corresponding local clock signal in step 51. This also applies to the replacement timing generators which keep their respective internal oscillator in synchronism with that of the main timing generator T₁.

In step 52 a fault occurs due to the fact that the timing generator fails for at least some of the nodes of the network due to a defect and/or a line break. A replacement timing generator must then be activated for the relevant nodes of the network. In step 53, a timing generator Tⱼ from the set of replacement timing generators T₂ to Tₙ checks whether it is receiving a data message from a replacement timing generator with higher priority after no further data message has been received from the main timing generator T₁ after a period of dead time. If this is so, the timing generator Tⱼ utilizes the data message of the timing generator with the next highest priority for synchronizing its internal oscillator in step 54. If, however, the timing generator Tⱼ cannot receive a data message from a timing generator with the next highest priority after a period dead time, this timing generator Tⱼ automatically activates itself in step 55 by sending out data messages for synchronization. This timing generator Tⱼ is then used as replacement timing generator for the synchronization, at least for a subnetwork.

When the network has split into different subnetworks, there can be different replacement timing generators for the different subnetworks due to the check in step 53. Again, it is of particular advantage in this context that the check occurs remotely in the individual replacement timing generators, thus providing a maximum of flexibility with regard to failure redundancy.

In summary, the invention relates to a system and method for introducing redundancy mechanisms into a communication system, comprising the following steps:

a. Transmission of a data message for synchronization from a timing generator via disjoint paths to the nodes,

b. In the case of an interruption of the transmission in one of the disjoint paths:

i. Transmission of the data message from the timing generator via a first partial path of the interrupted path and

ii. Transmission of the data message from the timing generator via the uninterrupted path and from there via a second partial path of the interrupted path.

The method here is therefore one for synchronizing nodes of a communication system, particularly an automation system, and a corresponding computer program and system.

We claim:

1. A method for synchronizing nodes of a communication system, comprising transmission of a data message for synchronization from a timing generator via disjoint paths to the nodes wherein in the event of an interruption of the transmission in one of the disjoint paths the data message is transmitted via a first partial path of the interrupted path and via an uninterrupted path and from there via a second partial path of the interrupted path.

2. The method for synchronizing nodes of a communication system, comprising transmission of a data message for synchronization from a timing generator having the highest priority to the nodes and wherein if a timing generator having a lower priority does not receive a data message of a timing generator having a higher priority, the data message is transmitted from a timing generator having a lower priority to at least a subset of the nodes.

3. A method for synchronizing nodes of a communication system, comprising transmission of data messages for synchronization from at least two timing generators having different priority to the nodes and selecting the data message from a timing generator with the highest priority from the data messages received by a node.

4. The method according to claims 1, 2 or 3, wherein the timing generator having the highest priority synchronizes all other timing generators.

5. The method according to claims 1, 2 or 3, wherein data for synchronization in the data messages of the timing generators having different priorities are essentially identical.

6. The method according to claims 1, 2 or 3, wherein each data message contains the priority of the timing generator which has sent the data message.

7. The method according to claim 3, wherein during the selection, the timing generator having the next highest priority automatically becomes the timing generator with the highest priority.

8. The method according to claim 7, wherein a priority identification code of the timing generator having the next lower priority is incremented.

9. The method according to claims 1, 2 or 3, wherein each of the data messages contains a priority identification code of the corresponding timing generator and the selection of a timing generator with the highest priority in a node takes place on the basis of the priority identification codes.

10. The method according to claims 1, 2 or 3, in which the timing generators receive and/or can obtain information on the timing generators existing or planned in the system.

11. The method according to claims 1, 2 or 3, wherein a selection and prioritization of the timing generators is carried out at least once during system start-up and/or the timing generators are prioritized through planning.

12. The method according to claims 1, 2 or 3, wherein a user uses a clock signal having the highest priority or a signal weighted from all clock signals.

13. A communication system for carrying out the method according to claims 1, 2 or 3.

14. A computer program product, comprising computer-readable means for carrying out the method according to claims 1, 2 or 3, when the computer program is executed in a communication system.
